(19) United States
(12) Patent Application Publication
(10) Pub. No.: US 2009/0181705 A1
(43) Pub. Date: Jul. 16, 2009

(54) MAIL TRANSMISSION SYSTEM AND METHOD AND PUSH MAIL SERVER

(75) Inventor: Weihua YIN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/408,350

(22) Filed: Mar. 20, 2009

Related U.S. Application Data
(63) Continuation of application No. PCT/CN2007/070751, filed on Sep. 21, 2007.

(30) Foreign Application Priority Data
Sep. 22, 2006 (CN) 200610139755.5

(51) Int. Cl. H04W 4/20; G06F 15/16

(52) U.S. Cl. 455/466; 709/206

(57) ABSTRACT

A mail transmission system and method is disclosed, where a push mail server stores a mobile terminal identification and email-box information in an email server bound to the identification. The push mail server further retrieves an email from the email-box in the email server and converts the email into a mobile network message, and transmits the mobile network message and the mobile terminal identification bound to the email-box to a mobile network server. The mobile network server transmits the received mobile network message to a corresponding mobile terminal according to the received mobile terminal identification. A push mail server, a mobile mail receiving/sending system and a method for sending and receiving a mail by a mobile terminal are disclosed. The technical solutions of various embodiments of the invention enable a mobile terminal to receive and send emails based on an open communication protocol.

### CROSS-REFERENCE TO RELATED APPLICATIONS

This application is a continuation of International Patent Application No. PCT/CN2007/070751, filed Sep. 21, 2007, which claims priority to Chinese Patent Application No. 200610139755.5, filed Sep. 22, 2006, both of which are hereby incorporated by reference in their entirety.

### FIELD OF THE INVENTION

The present invention relates to the technical fields of mobile communication and mail transmission, and more particularly, to a mail transmission system and method and a push mail server.

### BACKGROUND

With the emergence of computer network, the arising of E-mail, as a technology that implements non-proprietary mail transmission via network communication, allows people to exchange an electronic medium mail using a computer connected to the Internet. As a result, the email is widely used in the Internet.

With the development of mobile communication technologies, various information services based on the mobile communication network are rapidly developed. For example, Multimedia Messaging Server (MMS) is developed based on Short Messaging Service (SMS) and Enhanced Messaging Service (EMS), which implements the transmission of information content in rich media format such as text, picture, audio and video between a mobile terminal and a service provider/content provider (SP/CP).

Mobile terminals are far more widely used among people than are computers. Furthermore, the mobile terminals have a flexible and convenient mobility. Thus, browsing and transmitting emails using mobile terminals may find wider applications. As a result, PUSH Mail technology has been extensively used at a certain level.

The present Push Mail in use is a whole set of a private mail system composed of mobile terminals and servers, and is primary used for group users such as a corporate or an organization.

FIG. 1 is a schematic diagram of the architecture for the conventional Push Mail. As shown in FIG. 1, in this technical solution, besides an Email Server 101, a PUSH Mail Server 102 is provided for the corporate users. The proprietary mobile terminal 103 used by a mobile user, when the Email server 101 of the corporate users receives a mail, automatically notifies the Push Mail Server 102, which then notifies the proprietary mobile terminal 103 about the status change of the corporate mailbox, through a proprietary protocol and via a wireless network. The proprietary mobile terminal 103 initiates the related operations to perform receiving, browsing, and deleting of the mail.

However, the current Push Mail is a private mail system, which is only targeted at specific corporate users and therefore lacks openness. In addition, during the mail pushing, a mobile user must use a proprietary mobile terminal to support the service, which is not universally available.

### SUMMARY

The invention provides a mail transmission system, which enables a non-proprietary mobile terminal based on an open communication protocol to receive emails in a mobile communication network.

The invention provides a push mail server, which enables a non-proprietary mobile terminal based on an open communication protocol to receive emails in a mobile communication network.

The invention further provides a mail receiving/sending system, which enables a non-proprietary mobile terminal based on an open communication protocol to receive/send emails in a mobile communication network.

The invention provides a method for mail transmission, which enables a non-proprietary mobile terminal based on an open communication protocol to receive emails in a mobile communication network.

The invention provides a method for mail transmission, which enables a non-proprietary mobile terminal based on an open communication protocol to send emails in a mobile communication network.

The invention provides a method for receiving a mail by a mobile terminal, which enables a non-proprietary mobile terminal based on an open communication protocol to receive emails in a mobile communication network.

The invention provides a method for sending a mail by a mobile terminal, which enables a non-proprietary mobile terminal based on an open communication protocol to send emails in a mobile communication network.

To meet the above objectives, the technical solutions of the invention are implemented as follows.

The invention discloses a mail transmission system including a push mail server.

The push mail server is adapted to store a mobile terminal identification and information of an email-box bound to the mobile terminal identification, retrieve an email from the email-box and convert the email into a mobile network message for transmission, and carry the mobile terminal identification bound to the email-box while transmitting the mobile network message.

The invention discloses a push mail server including: (1) a terminal binding subsystem adapted to store an identification of a mobile terminal, and information of an email-box in an email server bound to the identification of the mobile terminal, wherein the mobile terminal is registered with and subscribes to a push mail service; (2) a mail push core processing module adapted to deliver push notifications and forward emails according to a binding relationship between the mobile terminal and the mailbox stored in the terminal binding subsystem; (3) a mail protocol interface module being adapted to communicate with the email server to retrieve and send the emails, and inquire about change information of a mailbox according to the inquiry request about information of changes of a mailbox initiated by the mail push core processing module; and (4) a multimedia message protocol conversion module connected to the mail push core processing module and adapted to communicate with a multimedia message center, and implement a conversion between a multimedia message format and an email format.

The invention discloses a mobile mail receiving/sending system including an email server. The system further includes a push mail server and a multimedia message service center communicatively connected to the push mail server.

The push mail server is adapted to store a mobile terminal identification and information of an email-box bound to the identification, retrieve an email from an email-box in the email server and convert the email into a multimedia message and transmit the multimedia message to the multimedia message service center, and carry the stored mobile terminal identification while transmitting the multimedia message.

The multimedia message service center is adapted to deliver the multimedia message according to the received mobile terminal identification.

The invention discloses a method for mail transmission, including: obtaining an email from an email-box and converting the email into a mobile network message, wherein the mobile network message carries a mobile terminal identification bound to the email-box for transmission, according to a pre-stored binding relationship between the mobile terminal identification and the information of the email-box.

The invention discloses a method for mail transmission including: (1) transmitting, by a mobile terminal, a mobile network message and information of a receiver's email-box to a mobile network server; (2) transmitting, by the mobile network server, the received mobile network message and the information of the receiver's email-box to a push mail server; and (3) converting, by the push mail server, the received mobile network message into an email, and transmitting the email to the email-box in the email server corresponding to the information of the receiver's email-box.

The invention discloses a mail receiving method by a mobile terminal. The method includes: (1) inquiring, by a push mail server, about information of changes of a mailbox in an email server bound to an identification of a mobile terminal, according to the identification of the mobile terminal which is registered with and subscribes to a push mail service; (2) transmitting, by the push mail server, prompt information of receiving an email to the mobile terminal, after retrieving the information of the changes of the mailbox; (3) retrieving, by the push mail server, the email from the email server, after the mobile terminal transmits an instruction for retrieving the email to the push mail server, and converting the email into a multimedia message and transmitting the multimedia message to a multimedia message service center; and (4) delivering, by the multimedia message service center, the multimedia message to the mobile terminal, and returning mail delivery result information to the push mail server.

The invention discloses a method for sending a mail by a mobile terminal. The method includes: (1) transmitting, by a mobile terminal that is registered with and subscribes to a push mail service, a multimedia message and information of a mailbox of a mail receiver to a multimedia message service center; (2) transmitting, by the multimedia message service center, the multimedia message and the information of the mailbox of the mail receiver to a push mail server; (3) transmitting, by the multimedia message service center, information on completion of mail sending to the mobile terminal; and (4) converting, by the push mail server, the multimedia message into an email, and transmitting the email to a corresponding email server, according to the information of the mailbox of the mail receiver.

It can be seen from the above technical solutions that, in the present invention, a push mail server stores a mobile terminal identification and email-box information in an email server bound to the identification; the push mail server retrieves an email from the email-box of the email server and converts the email into a mobile network message, and transmits the mobile network message and the mobile terminal identification bound to the email-box to a mobile network server; the mobile network server transmits the received mobile network message to a corresponding mobile terminal, according to the received mobile terminal identification. By the above technical solution, a mobile terminal based on an open communication protocol may receive/send emails in the mobile network.

### BRIEF DESCRIPTION OF THE DRAWINGS

FIG. 1 is a schematic diagram of the architecture of the current Push Mail technical solution;

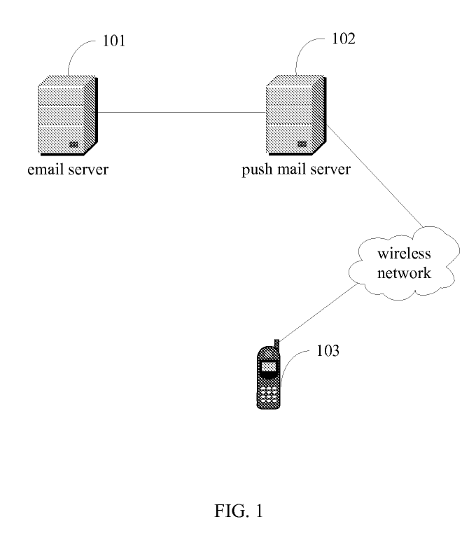

FIG. 2 is a structural block diagram of a Push Mail Server of the invention;

FIG. 3 is a structural block diagram of a mobile mail receiving/sending system of the invention;

FIG. 4 is a flow chart of a first embodiment of a method for mail transmission of the invention; and

FIG. 5 is a flow chart of a second embodiment of a method for mail transmission of the invention.

### DETAILED DESCRIPTION

The present invention aims to solve the problem of lacking openness and universality in the current Push Mail technology and provides a more open technical solution of mail transmission for both corporate and individual users, which allows a mobile user to receive and send emails timely in the mobile communication network using an ordinary mobile terminal. Therefore it has wide and universal applications.

A mail transmission system of the invention includes a push mail server adapted to store a mobile terminal identification and email-box information in an email server bound to the identification, obtain an email from the email-box in the email server and convert it into a mobile network message, and transmit the mobile network message and the mobile terminal identification bound to the email-box to a mobile network server. The mobile network server transmits the mobile network message to the corresponding mobile terminal according to the received mobile terminal identification.

Before retrieving an email from the email-box in the email server, the push mail server is further adapted to transmit prompt information to the mobile terminal according to the mobile terminal identification bound to the email-box, and retrieve the email from the email-box after receiving an instruction to retrieve the email returned from the mobile terminal. The push mail server is further configured to receive a mobile network message and email-box information of a receiver transmitted by the mobile network server, convert the received mobile network message into an email, and transmit the email to an email-box corresponding to the email-box information of the receiver in the email server.

In the above process, the mobile network server may be a short message center, and accordingly, the mobile network message is a short message. Alternatively, the mobile network server may be a multimedia message center, and accordingly, the mobile network message is a multimedia message.

To make the technical solution of the invention more apparent, in the following, the push mail server and mail receiving/sending system in the embodiments of the invention will be illustrated with reference to the accompanying figures and with an example of the mobile network server being a multimedia message service center and an example of the mobile network message being a multimedia message.

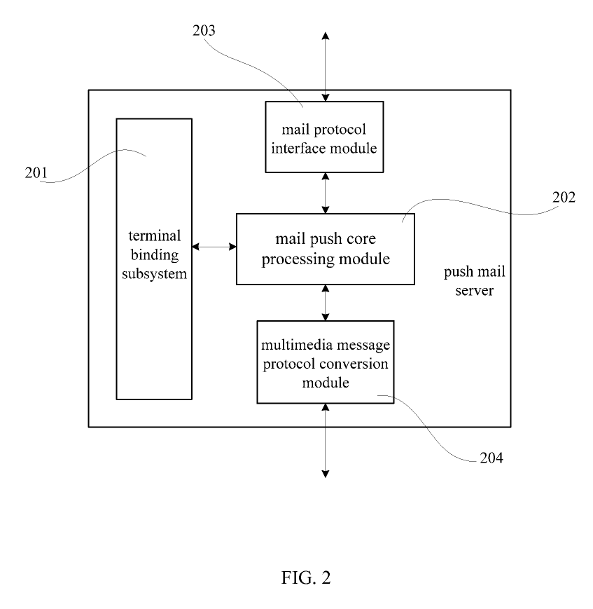

FIG. 2 is a structure block diagram of a push mail server of the invention. As shown in FIG. 2, the push mail server includes a terminal binding subsystem 201, a mail push core processing module 202, a mail protocol interface module 203, and a multimedia message protocol conversion module 204.

The terminal binding subsystem 201 is adapted to store an identification of a mobile terminal which has registered with and subscribed to a push mail service and email-box information in an email server bound to the mobile terminal identification. The mail push core processing module 202 is adapted to deliver a push notification and forward a mail according to the binding relationship between the mobile terminal and the mailbox stored in the terminal binding subsystem 201. The mail protocol interface module 203 is responsible for the communication with the email server and is adapted to retrieve or send a mail, and inquire about change information of a mailbox according to the inquiry request about change information of a mailbox initiated by the mail push core processing module 202. The multimedia message protocol conversion module 204 connected to the mail push core processing module 202 is responsible for the communication with the multimedia message center and is adapted to convert between a multimedia message format and a mail format.

The delivering of the push notification is as follows.

The mail push core processing module 202 inquiries about change information of a mailbox in an email server via the mail protocol interface module 203, and notifies a mobile terminal of the change information of the mailbox according to the mobile terminal identification bound to the mailbox stored in the terminal binding subsystem 201. Here, the mobile terminal identification uniquely identifies a mobile terminal. For example, it may be a mobile phone number.

The process for the mobile terminal to retrieve a mail is as follows.

The mobile terminal issues an instruction to retrieve a mail to the mail push core processing module 202, which inquiries about the mailbox information bound to the mobile terminal stored in the terminal binding subsystem 201 and retrieves the mail from the bound mailbox via the mail protocol interface module 203. The mail push core processing module 202 transmits the retrieved mail and the mobile terminal information (which may be stored upon receiving the instruction from the mobile terminal or may be inquired again from the terminal binding subsystem upon retrieving the mail) to the multimedia message protocol conversion module 204. The multimedia message protocol conversion module 204 converts the mail into a multimedia message format and transmits it to the multimedia message center with the mobile terminal identification. The multimedia message center transmits the mail as a multimedia message to the mobile terminal.

The process for the mobile terminal to send a mail is as follows.

Upon receiving the mail represented in a multimedia message format transmitted by the multimedia message center, the multimedia message protocol conversion module 204 converts the mail into a mail format and transmits it to the mail push core processing module 202. The mail push core processing module 202 inquiries about the mailbox information bound to a receiver mobile terminal stored in the terminal binding subsystem 201 and transmits the mail to the mailbox bound to the receiver mobile terminal via the mail protocol interface module 203 according to the mailbox information.

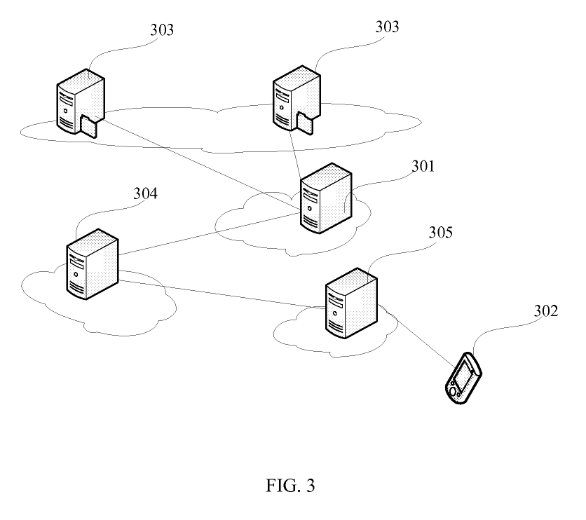

FIG. 3 is a structure block diagram of a mobile mail receiving/sending system of the invention. In FIG. 3, there are mainly arranged in a communication network an email server 303, a push mail server 301, and a mobile terminal 302 with multimedia message processing capability that interconnect and communicate with each other through the communication network. A multimedia message service center 304 is also arranged in the communication network and communicatively connected with the push mail server 301.

The push mail server 301 may be a push mail server shown in FIG. 2. The email server 303 may be an email server for corporate users based on a private communication protocol. It may also be a non-proprietary email server based on an open communication protocol. The multimedia message service center 304 may be communicatively connected with the push mail server 301 through POP3 and SMTP over MM3 or MM7 signaling.

Furthermore, the multimedia message service center 304 may also communicatively connect to a wireless session protocol gateway 305 arranged in the communication network through the MM1 signaling. The mobile terminal 302 is connected to the communication network through the wireless session protocol gateway 305.

The mobile terminal 302 which receives/sends email based on the above mobile email receiving/sending system must be a mobile terminal which has registered with and subscribed to the push mail service in advance. The mobile user may subscribe to the push mail service in various ways, such as using WAP, WEB, dialing a service line of an operator or being served in a service center.

The method for mail transmission according to an embodiment of the invention will be described in the following based on the mail transmission system and mail push server in the above embodiments.

A method for mail transmission according to the invention includes the following process.

First, a push mail server inquiries about change information of a mailbox in an email server uniquely bound to an identification of a mobile terminal, according to identification information of the mobile terminal that has registered with and subscribed to the push mail service. When a mobile user registers with and subscribes to the push mail service, the push mail server obtains the user's authorization for accessing a mailbox in the email server specified by the mobile user. The push mail server may determine whether there is any change of the mailbox status between the current access and the previous one using a predefined program. That is, it may determine whether there is any new mail. When there is a change, the following steps are executed.

Next, after obtaining the change information of the mailbox, the push mail server transmits prompt information that a new mail is received to the mobile terminal according to the stored mobile terminal identification bound to the mailbox.

Thereafter, after the mobile terminal issues an instruction to retrieve a mail to the push mail server, the push mail server then receives the mail from the email server and converts the mail into a mobile network message and transmits it to the mobile network server.

Finally, the mobile network server delivers the converted mobile network message to the mobile terminal and returns a mail delivery completion message to the push mail server.

It is possible to send an email to a mobile user using the above steps.

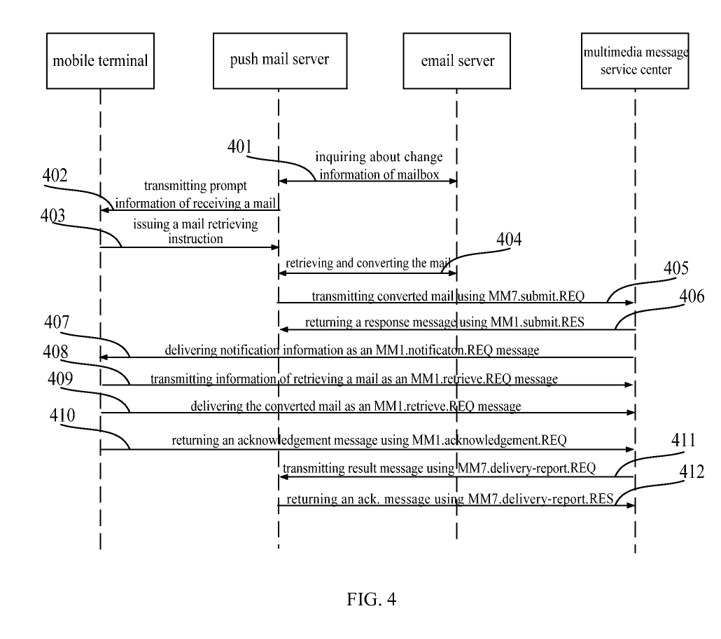

FIG. 4 is a flow chart of a first embodiment of the method for mail transmission of the invention. In FIG. 4, a multimedia message service center is provided as an example of a mobile network server to implement sending an email to a mobile terminal, where the following steps are included.

Step 401: At a fixed time or in a round-robin way, the push mail server inquiries about change information of a mailbox (e.g., the arrival of a new mail and receipt of a sent mail) in an email server bound to a unique identification of a mobile terminal (e.g., a mobile terminal number), according to identification information of the mobile terminal which has registered with and subscribed to the push mail service.

Step 402: After retrieving the change information of the mailbox, the push mail server transmits prompt information of receiving a mail to the mobile terminal via a short message center or a VAS message submission interface of a short message gateway, through a short message, WAP push, etc.

Step 403: The mobile terminal issues an instruction to retrieve a mail to the push mail server.

Step 404: The push mail server retrieves the mail from the email server by employing a message carried by protocols such as FTP, HTTP, SMTP, POP3 IMAP, etc., and converts the body and attachment of the mail into a multimedia message format according to the multimedia message encapsulation method defined in the latest version of OMA-MMS-ENC.

Step 405: The push mail server transmits the mail converted to a multimedia message format, i.e., the multimedia message, to the multimedia message service center as an MM7_submit.REQ message.

Step 406: The multimedia message service center returns a response message to the push mail server using MM1_submit.RES.

Step 407: The multimedia message service center delivers notification information to the mobile terminal as an MM1_notificatino.REQ message.

Step 408: The mobile terminal transmits information extracted from the mail in a multimedia message format to the multimedia message service center as an MM1_retrieve.REQ message.

Step 409: The multimedia message service center delivers the mail converted into a multimedia message format to the mobile terminal as an MM1_retrieve.RES message.

Step 410: After retrieving the mail, the mobile terminal returns an acknowledge message to the multimedia message service center using MM1_acknowledement.REQ.

Step 411: The multimedia message service center transmits a mail delivery result message to the push mail server using MM7_delivery_report.REQ.

Step 412: The push mail server returns an acknowledge message to the multimedia message service center using MM7_delivery_report.RES.

Another method for mail transmission of the invention includes the following procedure.

First, a mobile terminal which has registered with and subscribed to the push mail service transmits a compiled mobile network message and a receiver's mailbox information to a mobile network server.

Next, the mobile network server transmits the received mobile network message and the receiver's mailbox information to a push mail server.

Then, the mobile network server transmits information on completion of message sending to the mobile terminal.

Finally, the push mail server converts the mobile network message into a mail format and transmits the converted mail to the email server according to the receiver's mailbox information.

Sending emails by a mobile terminal can be implemented using the above steps.

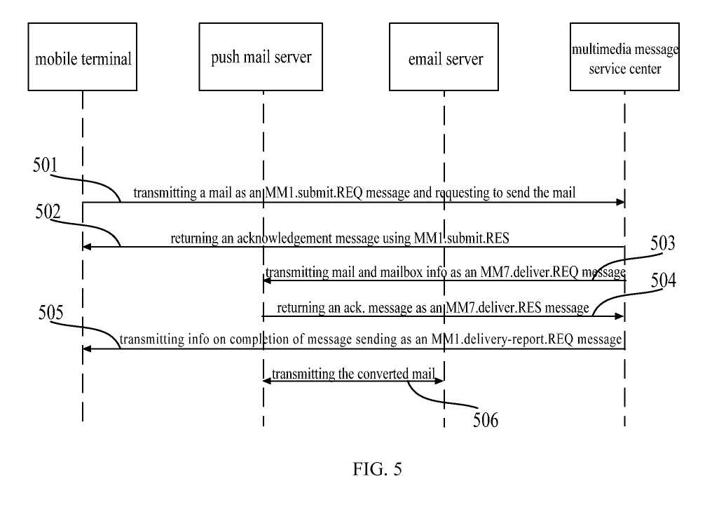

FIG. 5 is a flow chart of a second embodiment of the method for mail transmission of the invention. In FIG. 5, a multimedia message service center is still provided as an example of a mobile network server to implement sending an email to a mobile terminal, where the following steps are included.

Step 501: A mobile terminal which has registered with and subscribed to the push mail service compiles a mail in a multimedia message format directly or using a private terminal application, and transmits the mail to the multimedia message service center as an MM1_submit.REQ message to request mail transmission. Here, the mail in a multimedia message format is a multimedia message.

Step 502: The multimedia message service center returns an acknowledge message of the mail receiving result to the mobile terminal using MM1_submit.RES.

Step 503: The multimedia message service center authorizes the mobile terminal and determines whether the mobile terminal has registered with and subscribed to the push mail service in advance. For an authorized mobile terminal, the multimedia message service center transmits the mail in a multimedia message format and the mailbox information of a mail receiver to the push mail service as an MM7_deliver.REQ message. For an unauthorized mobile terminal, the push mail service ends.

Step 504: The push mail server returns an acknowledge message of the mail sending result to the multimedia message service center as an MM7_deliver.RES message.

Step 505: The multimedia message service center transmits information on completion of mail sending to the mobile terminal as an MM1_deliver.RES message.

Step 506: The push mail server converts the mail into a mail format according to a way of partitioning an encapsulated element of a multimedia message into an attachment in a mail format as defined by the latest version of OMA-MMS-ENC, and transmits the converted mail to the email server where the mailbox is located using a messages carried by protocols such as FTP, HTTP, SMTP, POP3, IMAP, etc., according to identification information of the mail receiver.

In the above embodiments, the invention is described by taking a multimedia message service center as an example. The mail transmission procedure is the same as that of the above embodiments when the mobile network server is a short message center or a wireless access gateway, which is not elucidated here.

In summary, the invention provides a total solution to receiving/sending a mail in a mobile way for a non-proprietary mobile terminal, based on an email and mobile network message service. The solution may fully utilize an existing open protocol and network resources to address the issue of technical openness. For example, mail receiving and sending may be provided for an MMS mobile terminal by implementing MM7/MM3, POP3 and SMTP protocols using a private push mail server. During mail receiving, the MMS mobile terminal may be configured to retrieve a mail in a multimedia format by a mail query access which simulates a mobile client and which is initiated by the push mail server towards a user customized mail system and the conversion of a mail format. During mail transmission, the push mail server converts the mail in a multimedia format and pushes the mobile mail according to identification information of the mail receiver. The invention has the following advantages over the existing push mail technical solutions: it makes the mail push system to have good openness by using an existing open protocol and network resources; by using a message inbox/outbox of an existing mobile terminal, most non-proprietary mobile terminals can be used and no private terminal is required.

Finally, although the invention has been described in detail by reference to some exemplary embodiments, the above embodiments are intended to illustrate rather than limit the technical solutions of the invention. Those skilled in the art should appreciate that any modifications and equivalent substitutions for the invention are possible without departing the spirit and scope of the invention.

What is claimed is:

1. A mail transmission system comprising a push mail server, wherein the push mail server is adapted to store a mobile terminal identification and information of an email-box bound to the mobile terminal identification, retrieve an email from the email-box and convert the email into a mobile network message for transmission, and carry the mobile terminal identification bound to the email-box while transmitting the mobile network message.

2. The system of claim 1, wherein the push mail server is further adapted to transmit prompt information to the mobile terminal according to the mobile terminal identification bound to the email-box before retrieving the email from the email-box, and retrieve the email from the email-box after receiving an instruction for retrieving the email returned from the mobile terminal.

3. The system of claim 1, wherein the push mail server is further adapted to receive a mobile network message carrying the information of the email-box of a receiver, convert the received mobile network message into an email, and transmit the email to an email-box corresponding to the information of the email-box of the receiver.

4. A push mail server comprising:
a terminal binding subsystem adapted to store an identification of a mobile terminal, and information of an email-box in an email server bound to the identification of the mobile terminal, wherein the mobile terminal is registered with and subscribes to a push mail service;
a mail push core processing module adapted to deliver push notifications and forward emails according to a binding relationship between the mobile terminal and the email-box stored in the terminal binding subsystem;
a mail protocol interface module adapted to communicate with the email server to retrieve and send the emails and inquire about change information of a mailbox according to the inquiry request about information of changes of the mailbox initiated by the mail push core processing module; and
a multimedia message protocol conversion module connected to the mail push core processing module, the multimedia message protocol conversion module adapted to communicate with a multimedia message center to implement a conversion between a multimedia message format and an email format.

5. The push mail server of claim 4, wherein:
the mail push core processing module is adapted to retrieve the emails in the email-box via the mail protocol interface module, inquire the mobile terminal identification stored in the terminal binding subsystem, and transmit the email and the mobile terminal identification to the multimedia message protocol conversion module; and
the multimedia message protocol conversion module is adapted to convert the received email in the email format into a multimedia message in the multimedia message format, transmit the multimedia message to the multimedia message center, and carry the mobile terminal identification within the multimedia message.

6. The push mail server of claim 4, wherein:
the multimedia message protocol conversion module is adapted to convert the email from the multimedia format into the email format and transmit the converted email to the mail push core processing module, after receiving the email; and
the mail push core processing module is adapted to inquire about the information of the email-box bound to a receiver mobile terminal stored in the terminal binding subsystem and transmit the email to the email-box bound to the receiver mobile terminal via the mail protocol interface module, according to the information of the email-box.

7. A mobile mail receiving/sending system comprising an email server, a push mail server, and a multimedia message service center communicatively connected to the push mail server, wherein
the push mail server is adapted to store a mobile terminal identification and information of an email-box bound to the identification, retrieve an email from an email-box in the email server and convert the email into a multimedia message, transmit the multimedia message to the multimedia message service center, and carry the mobile terminal identification while transmitting the multimedia message; and
the multimedia message service center is adapted to deliver the received multimedia message according to the received mobile terminal identification.

8. The mobile mail receiving/sending system of claim 7, wherein the multimedia message service center is communicatively connected to the push mail server via one of MM3 and MM7 signaling.

9. The mobile mail receiving/sending system of claim 7, wherein the email server is one of a proprietary email server for corporate users based on a proprietary communication protocol and a non-proprietary email server based on an open communication protocol.

10. The mobile mail receiving/sending system of claim 9, wherein the multimedia message service center is further communicatively connected to a wireless session protocol gateway arranged in a communication network via MM1 signaling, and transmits the multimedia message through the wireless session protocol gateway.

11. A method for mail transmission comprising:
retrieving an email from an email-box and converting the email into a mobile network message, wherein the mobile network message carries a mobile terminal identification bound to the email-box for transmission according to a pre-stored binding relationship between the mobile terminal identification and information of the email-box.

12. The method of claim 11, before retrieving the email from the email-box, the method further comprising: transmitting prompt information to the mobile terminal according to the mobile terminal identification bound to the email-box and retrieving the email from the email box after receiving an instruction for retrieving a mail returned by the mobile terminal.

13. The method of claim 12, before retrieving the email from the email-box further comprising: inquiring about the email-box in an email server and retrieving a new email from the email server when there is a new mail in the email-box.

14. A method for mail transmission comprising:
transmitting, by a mobile terminal, a mobile network message and information of an email-box of a receiver to a mobile network server;
transmitting, by the mobile network server, the received mobile network message and the information of the email-box of the receiver to a push mail server; and
converting, by the push mail server, the received mobile network message into an email and transmitting the email to the email-box corresponding to the information of the email-box of the receiver in the email server.

15. A method for receiving a mail by a mobile terminal, comprising:
inquiring, by a push mail server, about information of changes of a mailbox in an email server bound to an identification of a mobile terminal according to the identification of the mobile terminal which is registered with and subscribes to a push mail service;
transmitting, by the push mail server, prompt information of receiving an email to the mobile terminal after retrieving the information of changes of the mailbox;
retrieving, by the push mail server, the email from the email server after the mobile terminal issues an instruction for retrieving the email to the push mail server, converting the email into a multimedia message, and transmitting the multimedia message to a multimedia message service center; and
delivering, by the multimedia message service center, the multimedia message to the mobile terminal and returning mail delivery result information to the push mail server.

16. The method of claim 15, wherein the push mail server inquires about the information of changes of the mailbox in the email server at a fixed time or in a round-robin way.

17. The method of claim 15, wherein the push mail server transmits the prompt information of receiving the mail to the mobile terminal using a short message.

18. The method of claim 15, wherein the push mail server transmits the multimedia message to the multimedia message service center as an MM7_submit.REQ message, and the multimedia message service center returns a message to the push mail server using an MM7_submit.RES message after receiving the multimedia message.

19. The method of claims 15, before the multimedia message service center delivers the multimedia message to the mobile terminal, the method further comprising:
delivering, by the multimedia message service center, notification information to the mobile terminal as an MM1_notification.REQ message; and
transmitting, by the mobile terminal, information extracted from the multimedia message to the multimedia message service center as an MM1_retrieve.REQ message.

20. The method of claim 19, wherein delivering the multimedia message to the mobile terminal and returning mail delivery result information to the push mail server by the multimedia message service center comprises:
delivering, by the multimedia message service center, the multimedia message to the mobile terminal as an MM1_retrieve.RES message;
returning, by the mobile terminal, after receiving the multimedia message, an acknowledge message to the multimedia message service center using an MM1_acknowledgment.REQ message;
transmitting, by the multimedia message service center, mail delivery result information to the push mail server using an MM7_delivery_report.REQ message; and
returning, by the push mail server, another acknowledge message to the multimedia message service center using an MM7_delivery_report.RES message.
